(19) United States
(12) Patent Application Publication
(10) Pub. No.: US 2005/0265129 A1
(43) Pub. Date: Dec. 1, 2005

(54) Watch winder cabinet and watch winder apparatus

(76) Inventor: Charles Agnoff, Wilmington, NC (US)

Correspondence Address: WILLIAM J. MASON;MACCORD MASON PLLC, POST OFFICE BOX 1489, WRIGHTSVILLE BEACH, NC, 28480, US

(21) Appl. No.: 10/857,219

(22) Filed: May 28, 2004

(51) Int. Cl. G04C 1/00; G04B 3/00; G04B 5/00

(52) U.S. Cl. 368/206

(57) ABSTRACT

A cabinet supporting a plurality of watch winders includes an enclosure having a horizontal top wall with an opening, a rear wall, a front wall, a divider wall separating the enclosure into a rear support chamber and a front storage area. A watch winder support having a top wall and a generally upright watch winder panel having a raised position projecting above the enclosure through the top wall opening from the chamber, and a lowered position within the chamber with the upper surfaces of the enclosure and support top walls being in a plane, thereby preventing access to the watch winders and hiding the watch winders and any supported watches from view. A drive mechanism with a reversible electric motor is used to move the support between its raised and lowered positions.

### BACKGROUND OF THE INVENTION

(1) Field of the Invention

The present invention relates generally to a cabinet for storing a plurality of automatic watch winders used to wind self-winding watches, and in particular to a cabinet including a moveable support for a plurality of watch winders and a mechanism for raising the support for access to the watch winders, and lowering the support and watch winders and watches carried on the support into a chamber in the cabinet for secure, inconspicuous storage, while continuing to activate the watch winders as required.

(2) Description of the Prior Art

The winding mechanism of a self-winding watch is comprised of a ball bearing mounted pendulum or rotor that is connected through a gear reduction system to the mainspring of the watch. Generally, the rotor can rotate 360° in either direction. However, there are also so-called “hammer” shaped rotors in older self-winding watches that have a limited travel of 150° to 220° rotation. In either case when the watch is worn, the user's random and often rapid arm movements cause the rotor to swing back and forth inertially in both directions around the rotor axis, thereby winding the watch spring. The watch spring generally stores sufficient energy to keep the watch operating 36-48 hours, whether worn or not. Thus, when worn daily, the watch will be sufficiently wound to maintain continuous operation. However, if the watch is not worn regularly, the user must wind the watch, either manually or with a watch winder, or the watch will stop.

Watch winders are typically comprised of an electric drive mechanism that rotates a watch carrier adapted to hold a watch with the plane of the watch perpendicular to the axis of rotation. That is, the rotor axis is parallel to the axis of rotation of the drive mechanism, so that the watch rotates in the same plane as the hands of the watch. During the period of activation, the watch is completely rotated several times either in a clockwise or counter-clockwise direction or, alternately, reversing in both directions. During the 360° rotation of the watch, the rotor hangs downward, so that the watch rotates while the rotor is essentially stationary and the winding action is totally caused by gravity operation. That is, the motion is essentially the opposite from the way in which the winding mechanism is designed, i.e., rotation of the rotor around the rotor axis caused by inertial movement resulting from the wearer's random movements. As a result, the powered rotation of the watch must be controlled to limit the turns per day (TPD) to prevent damage or malfunction due to the forces exerted on the winding mechanism.

U.S. Pat. No. 6,254,270 to Agnoff, the present inventor, issued Jul. 3, 2001 and incorporated herein in its entirety, describes an alternative watch winder design in which a self-winding watch is mounted on a horizontal or inclined, e.g., 30°, shaft or spindle, with the watch band being positioned around the spindle so that the face of the watch is generally parallel to the axis of rotation, and moves along a circular pathway during rotation of the spindle. The orbital motion of the watch about the inclined axis causes the rotor to swing back and forth, or oscillate, thereby generally replicating the effect of a person's natural arm movements. When a 30° angle from horizontal is chosen, each rotation causes the rotary pendulum to move through an arc of 120°.

U.S. Pat. No. 6,543,929 to Agnoff, the present inventor, issued Apr. 8, 2003, and incorporated herein in its entirety, describes another type of watch winder that imparts a greater oscillation to the rotor, more closely simulating the bi-directional random inertial movement to which an automatic watch is subjected when worn, and enabling an automatic watch to be adequately wound in a shorter period of time without any concern for winding direction, and with less energy.

Generally, the watch winder described in the '929 patent is comprised of a watch carrier having a horizontal or inclined axis of rotation with the center of gravity of the carrier being laterally offset in a given direction from the axis of rotation, and a drive mechanism to rotate the watch carrier around the axis until the given direction, or center of gravity, is in the uppermost position, whereupon the carrier is free to rotate about the axis under the influence of both gravity and inertial force, causing the carrier to oscillate around the axis bi-directionally for several excursions.

The watch carrier supports one or more watches with the face of each watch being perpendicular to the axis of rotation of the carrier. That is, the axis of rotation of the watch pendulum or rotor is parallel to the axis of rotation of the carrier. As a result, the rapid oscillation of the watch carrier and the abrupt direction changes cause the rotor to spin about the rotor axis in much the same manner as the spinning that occurs when the watch is worn by a user. Moreover, since the rotor tends to spin entirely or largely around the rotor axis for several excursions, as opposed to only the single 120° or so achieved with prior art devices, the watch is more rapidly wound, and less energy is required, prolonging battery and/or winder life.

While the above prior art watch winders are suitable for winding one or more watches, many individuals or commercial establishments own more self-winding watches than can be wound on a single watch winder. These watch owners must, therefore, use more than one watch winder in order to keep all of the watches in their possession wound when not being worn. Each watch winder must be separately plugged into an electrical outlet, and must be placed on some surface while being used. As a result, multiple watch winders create clutter and inconvenience. Moreover, multiple self-winding watches represent a substantial monetary investment.

In order to minimize this clutter and provide a degree of security, it has also been proposed to mount a plurality of watch winders of the type described above in a lockable cabinet or enclosure. Generally, a watch winder support panel having a front face is positioned within an enclosure with the front face being toward an access door. The door is lockable and normally includes a transparent panel. A plurality, e.g., from about 2 to about 24, watch winders are mounted in openings in the support panel. Wiring within the enclosure connects the watch winders to a common source of electricity. Each watch winder includes means for controlling the time and frequency of activation.

While apparatus of the latter type are useful in holding and operating a plurality of watch winders, there is still a need for an apparatus for use in simultaneously winding multiple watches that will provide greater security for the watches.

### SUMMARY OF THE INVENTION

Generally, the present invention is comprised of a watch winder storage cabinet for enclosing a plurality of watch winders in a manner such that the watch winders, and watches mounted on the watch winders, are readily accessible for viewing or removal, or for mounting of additional watches on the watch winders, but which will securely and inconspicuously enclose the watch winders and watches when access is not desired. The present invention also relates to the combination of a cabinet of this type in combination with a plurality of watch winders supported by the cabinet.

Specifically, the watch winder storage cabinet is comprised of a top with an upper surface, a front, sides and a back. The cabinet front preferably includes one or more lockable doors to permit access into the cabinet. A watch winder support chamber is provided in the cabinet. Preferably, the chamber is located in the rear of the cabinet, behind a storage area in the front of the cabinet. The storage area may include one or more shelves. Opening the door or doors provides access into the storage area, but does not provide access into the support chamber.

The cabinet also includes a watch winder support comprised of a top with an upper surface, sides, a back, a bottom, and a generally upright watch winder mounting panel beneath the top and between the sides of the support. The mounting panel, which may be rearwardly inclined by up to about 15°, includes a plurality of openings to receive watch winders with the cross-section of the openings generally corresponding to the cross-section of the watch winder housing.

A drive means is positioned within the cabinet, e.g., in the lower part of the support chamber, and is attached to the lower part of the support. The drive means is adapted to move the support between raised and lowered positions. In the raised position, the support extends upwardly through an opening in the cabinet top to expose the watch winders carried on the support panel. In the lowered position, the support is completely enclosed within the cabinet chamber with the upper surface of the support top being in a plane with the upper surface of the cabinet top. Thus, when the support is in the lowered position, any watch winders and watches supported thereon are completely enclosed by the cabinet, preventing unauthorized access. In addition, the fact that the watch winder support even exists will not be readily apparent to uninformed persons since the only part of the support that is exposed is the support upper surface which appears to be a part of the cabinet upper surface.

Various types of drive mechanisms can be used to move the support between its raised and lowered positions. For example, the drive mechanism may be comprised of a first section attached to the cabinet and a telescoping second section attached to the watch winder support. Other suitable mechanisms of the type described in the description of the preferred embodiment are used to raise and lower televisions and the like, and are sold by Auton Motorized Systems, Valencia, Calif.

The drive mechanism motor may be remotely controlled by a receiver in communication with a switch in the motor circuit and a handheld transmitter. The motor circuit may also include a combination or key actuated lock in communication with a switch.

Generally, watch winders used with the present invention are comprised of a watch carrier having a horizontal or inclined axis of rotation, and a drive mechanism to rotate the watch carrier around the axis. For example, the drive mechanism may include a shaft rotated, e.g., at about 10-12 revolutions per hour, by electric motor that is connected to the shaft through a set of reduction gears. Since different styles of automatic watches have different winding requirements, normally determined by the number of desired rotations of the rotor within a given time period, a controller is also included for use in setting these parameters. The watch winder may be mounted in an outer case. Control knobs or switches can be mounted on the case to adjust the controller.

### BRIEF DESCRIPTION OF THE DRAWINGS

FIG. 1 is a perspective view of the cabinet with the watch winder support in the raised position.

FIG. 2 is a perspective view of the cabinet with the watch winder support in the lowered position.

FIG. 3 is a sectional front view of the cabinet showing the drive mechanism and watch winder support in the raised position.

FIG. 4 is a side view of the cabinet with the side wall removed to show the drive mechanism and watch winder support in the raised position.

FIG. 5 is a side view of a typical watch winder of the type that is used with the present apparatus.

FIG. 6 is a front view of a typical watch winder mounted on the mounting panel.

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

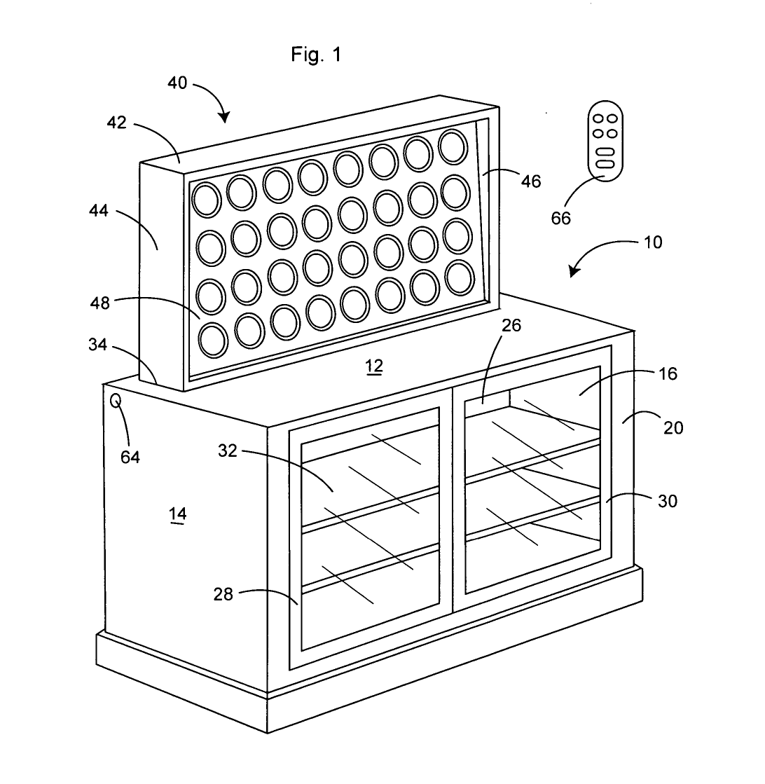

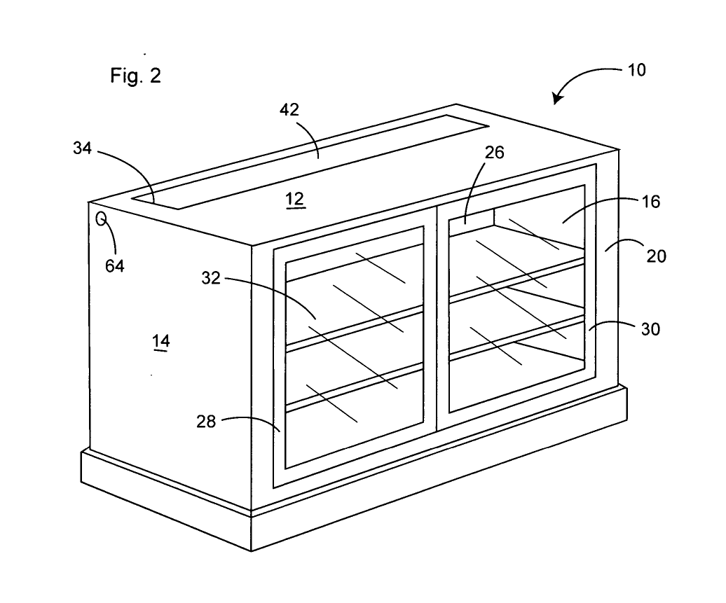

As best illustrated in FIGS. 1 and 2, cabinet, generally 10, is comprised of a top wall 12 with a horizontal upper surface, opposed parallel side walls 14 and 16, a rear wall 18, and a front wall 20. These walls together define a cabinet interior that is separated into a rear chamber 22 and a front section 24 by divider wall 26 mounted parallel to and spaced between rear wall 18 and front wall 20. Front wall 20 includes transparent, e.g., glass paneled, access doors 28 and 30. One or more shelves 32 are mounted within front section 24 between divider wall 26 and front wall 20. Top wall 12 includes opening 34. Divider wall 26 preferably has a mirrored front surface.

Watch winder support, generally 40, is comprised of a top wall 42 with a horizontal upper surface, spaced parallel side walls 44 and 46, and a watch winder mounting panel 48 beneath wall 42 and extending between side walls 44 and 46. As illustrated in FIG. 1, support 40 projects upwardly through opening 48 in cabinet top wall 12 when in its raised position.

When in the lowered position as illustrated in FIG. 2, the top surface of support top wall 42 is in a plane with the top surface of cabinet top wall 12. The outer dimensions of top wall 42 are the same as the inner dimensions of opening 34 and the top surfaces are of the same finish. Thus, support 40 is inconspicuous when in the lowered position. The illusion that the interior of cabinet 10 only includes shelves 32 is enhanced by the mirrored front surface of divider wall 26.

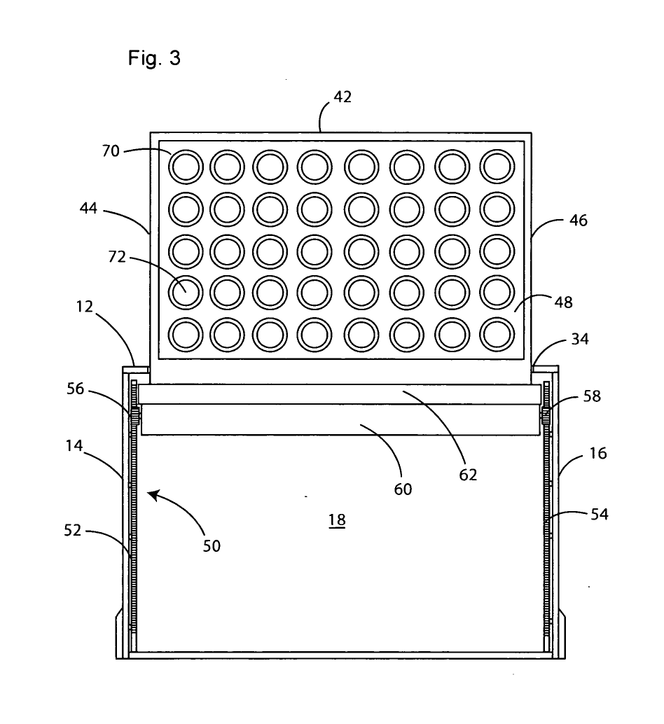

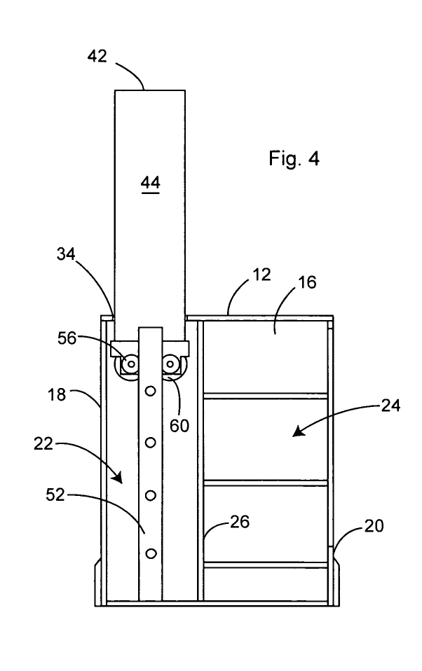

As illustrated in FIGS. 3 and 4, support 40 is mounted on a rack and pinion lift mechanism, generally 50, comprised of racks 52 and 54 affixed to the inner surfaces of inner walls 14 and 16, respectively, and pinions 56 and 58 that are rotated by reversible drive motor 60, mounted beneath mounting plate 62 holding support 40. Rotation of pinions 56 and 58 against racks 52 and 54, respectively, moves plate 62 and support either up or down. Control switches, not shown, can be positioned to engage a component of support 40 or mechanism 50 in a known manner to open the circuit when support 40 is at its fully raised or lowered position.

Electrical circuitry, not shown, connecting motor 60 to a power source also includes a manual lock 64 preventing motor 60 from being energized when support 40 is in its lowered position, thereby preventing unauthorized access to any watch winders or watches carried by support 40. A remote control transmitter 66 can also be used to open or close the electrical circuit to motor 60.

Support mounting panel 48 includes a plurality of openings 70 to receive watch winders 72. While panel 48 is shown with openings to receive forty watch winders, it will be understood that panels with a lesser or greater number of openings are within the scope of the invention.

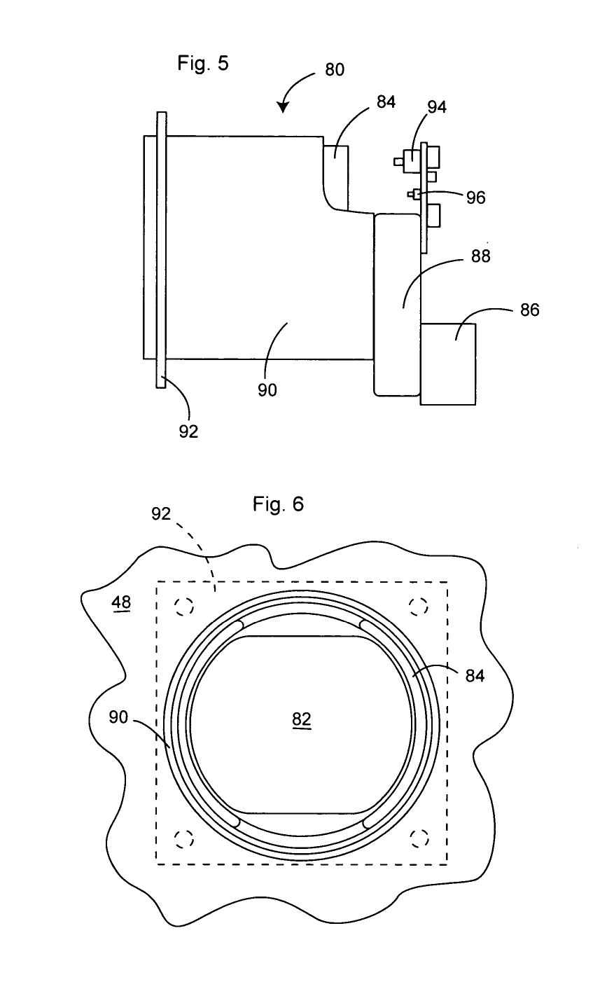

FIGS. 5 and 6 illustrate a typical watch winder, generally 80, shown mounted on mounting panel 48 in FIG. 6. It will be understood that the invention is not limited to any particular watch winder construction and that other watch winders can be mounted on the watch winder support. Watch winder 80 is comprised of a removable watch carrier 82 mounted in removable holder 84, which is rotated by electric motor 86 through a set of reduction gears 88. Housing 90 encloses the watch winder components. Attachment plate 92 is used to secure watch winder 80 to mounting plate 48. Removal of holder 84 permits access though housing 90 to a manual on/off switch 94 and a set switch 96 used to set the number of rotations of watch winder 80. In use, carrier 82 is removed from holder 84, a watch band is positioned around carrier 82 with the watch axially aligned on the front of carrier 82, and the carrier is then repositioned in holder 84. Motor 86 is periodically energized to rotate carrier 82.

Certain modifications and improvements will occur to those skilled in the art upon a reading of the foregoing description. It should be understood that all such modifications and improvements have been deleted herein for the sake of conciseness and readability but are properly within the scope of the following claims.

1. A cabinet for supporting a plurality of watch winders comprising:
a) an enclosure having an upper surface and a support chamber;
b) a watch winder support having a watch winder mounting panel, an upper surface, a raised position and a lowered position, said support extending above said enclosure upper surface when in its raised position and being within said chamber with said support upper surface in a plane with said enclosure upper surface when said support is in its lowered position; and
c) drive means in communication with said support for moving said support between said raised and lowered positions.

2. The cabinet of claim 1, further including a remote control transmitter for controlling said drive means.

3. The cabinet of claim 1, wherein said enclosure is a generally rectangular cabinet having a front, and a storage area within said enclosure accessible from the front of said enclosure, said support chamber being located behind said storage area.

4. The cabinet of claim 1, wherein said enclosure includes a rear wall, a front wall and a divider wall between said rear and front walls dividing said enclosure into a rear support chamber and a front storage area.

5. The cabinet of claim 1, wherein said mounting panel is an upright panel with a plurality of holes for receiving said watch winders.

6. The cabinet of claim 1, further including a storage area with shelves in front of said chamber.

7. The cabinet of claim 1, including a locking means to secure said support in said lowered position.

8. An apparatus for use in winding a plurality of watches comprising:
a) an enclosure having an upper surface and a support chamber;
b) a watch winder support having a watch winder mounting panel, an upper surface, a raised position and a lowered position, said support extending above said enclosure upper surface when in its raised position and being within said chamber with said support upper surface in a plane with said enclosure upper surface when said support is in its lowered position; and
c) drive means in communication with said support for moving said support between said raised and lowered positions; and
d) a plurality of watch winders mounted on said watch winder support.

9. The apparatus of claim 8, wherein said watch winder mounting panel is an upright mounting panel with openings for receiving said watch winders.

10. The apparatus of claim 9, wherein said mounting panel is tilted rearwardly by up to about 15°.

11. The apparatus of claim 8, wherein said support upper surface is rectangular with given dimensions, and said enclosure upper surface includes a rectangular opening having dimensions corresponding to said given dimensions, said support upper surface being positioned within said rectangular opening and in a plane with said enclosure upper surface when said support is in its lowered position.

12. The apparatus of claim 8, wherein said enclosure front surface includes access doors, said enclosure having a storage area behind said access doors, with said support enclosure being behind said storage area.

13. The apparatus of claim 8, wherein said drive means includes an electric motor in a first circuit and said watch winders include electric motors in a second circuit, said first circuit being independent of said second circuit.

14. The apparatus of claim 8, wherein said watch winders include electric motors in communication with a common power source.

15. An apparatus for use in winding a plurality of watches comprising:
a) an enclosure having a horizontal top wall with an upper surface, a rear wall, a front wall parallel to said rear wall, a divider wall between said front and rear walls dividing said enclosure into a rear support chamber and a front storage area;
b) a watch winder support having a top wall with an upper surface, and a generally upright watch winder mounting panel with a plurality of openings beneath said top wall, said support having a raised position extending above said enclosure upper surface, and a lowered position within said chamber with said support top wall upper surface in a plane with said enclosure top wall upper surface;
c) a plurality of watch winders mounted said panel plurality of openings, said watch winders having commonly-powered electric motors; and
d) drive means including a reversible electric motor in communication with said support for moving said support between said raised and lowered positions.

16. The apparatus of claim 15, wherein said enclosure front surface includes access doors.

17. The apparatus of claim 15, further including shelves within said storage area.

18. The apparatus of claim 15, wherein said drive means electric motor is remotely controlled.

19. The apparatus of claim 15, further including a locking means for securing said support in its lowered position.

20. The apparatus of claim 15, wherein said divider wall includes a mirrored front surface.
